(19) United States
(12) Patent Application Publication
(10) Pub. No.: US 2025/0187428 A1
(43) Pub. Date: Jun. 12, 2025

(54) DRIVE TRAIN COOLING UNIT FOR A VEHICLE

(71) Applicant: Robert Bosch GmbH, Stuttgart (DE)

(72) Inventors: Thomas Holzer, Karlsbad (DE); Dana Nicgorski, Burlington, MA (US); Denis Neher, Remchingen (DE)

(21) Appl. No.: 18/686,231

(22) PCT Filed: Aug. 3, 2022
(86) PCT No.: PCT/EP2022/071780

§ 371 Date: Feb. 23, 2024

(30) Foreign Application Priority Data
Aug. 25, 2021 (DE) 10 2021 209 305.1

(51) Int. Cl. B60K 11/04; B60K 1/00

(52) U.S. Cl. CPC B60K 11/04; B60K 2001/006

(57) ABSTRACT

The invention relates to a drive train cooling unit (10) for a partially electrically or fully electrically driven vehicle, with a fan (13), a condenser (11) for a refrigerant circuit (1) of the vehicle, and a radiator (12) for a coolant circuit (2) of the vehicle, wherein, in an air flow direction which can be caused by the fan (13), the fan (13) itself, the condenser (11), and the radiator (12) are connected together sequentially in series to form a cooling unit for a drive train of the vehicle, wherein, apart from the radiator (12) as main component (12) of the coolant circuit (2), a further main component (14, 15, 16, 17) of the coolant circuit (2) of the vehicle is integrated into the drive train cooling unit (10).

### BACKGROUND

The invention relates to a drive train cooling unit for a partially electrically or fully electrically driven vehicle. The invention also relates to a vehicle with an electric traction motor.

The heat of a drive train, a battery and/or other components of a partially electrically or fully electrically driven vehicle is dissipated to the surroundings via a coolant-to-air heat exchanger, referred to below as a radiator.—On the one hand, the radiator is part of a branched coolant circuit, the main components of which are a coolant pump, a coolant valve, and a coolant expansion tank. Water, a water-glycol mixture, or oil is used as a coolant. On the other hand, the radiator is part of a so-called Condenser Radiator Fan Module (CRFM), which can also be referred to as a drive train cooling unit or drive train cooling module.—The condenser, in turn, is part of a refrigerant circuit in the vehicle, wherein R1234yf, R744 (carbon dioxide), for example, can be used as a refrigerant.

Partially electrically and/or fully electrically driven vehicles present developers with completely new challenges when it comes to designing such vehicles. One of these fields is a twofold thermal management of the vehicles, on the one hand the thermal management of the drive trains of such vehicles and on the other hand the thermal management of the vehicles away from the drive trains (batteries, passenger compartments, etc.).—It is a task of the invention to provide a cost-effective drive train cooling unit (CRFM).

### SUMMARY

The problem of the invention is solved by means of a drive train cooling unit for a partially electrically or fully electrically driven vehicle; and by means of a vehicle with an electric traction motor. Advantageous further embodiments, additional features, and/or advantages of the invention are apparent from the following description.

The drive train cooling unit according to the invention comprises a fan, a condenser for a refrigerant circuit of the vehicle, and a radiator for a coolant circuit of the vehicle, wherein in an air flow direction which can be caused by the fan, the fan itself, the condenser, and the radiator are connected together sequentially in series to form a cooling unit for a drive train of the vehicle, a further main component of the coolant circuit of the vehicle being integrated into the drive train cooling unit apart from the radiator as the main component of the coolant circuit.—Viewed in one direction of a primary cooling air flow of the fan, the condenser can be set up in front of the radiator or the radiator in front of the condenser in the drive train cooling unit.

A main component is understood to be a sub-assembly (see below) and not a simple component, such as a pipe, hose, bracket, clamp, fastener, etc. of the coolant circuit. The further main component can be integrated inside and/or outside the drive train cooling unit. According to the invention, a complex and cost-intensive construction as well as a complex and cost-intensive assembly of cooling components as individual components of the vehicle is no longer necessary. Depending on the degree of integration of the drive train cooling unit, at least one cable harness, at least one communication connection, at least one (power) electronics, at least one mechanical interface, at least one hydraulic interface, etc. can be omitted. Furthermore, there is no comparatively high cost for mechanical and electrical component integration or for setting up communication.—This results in a significant overall cost reduction for cooling the components in a partially electrically or fully electrically driven vehicle.

The drive train cooling unit can be designed as a single functional and/or structurally closed assembly for cooling the vehicle's drive train, which can be installed as such on/in the vehicle. An assembly is a spatially self-contained object consisting of two or more lower-order sub-assemblies and/or components, which can be disassembled again. An individual part or component, on the other hand, is a technically described and manufactured object that cannot be dismantled non-destructively.—Here, a sub-assembly is defined in such a way that without it the vehicle can only function to a limited extent, whereas an assembly is defined in such a way that without it the vehicle can only function to an even more limited extent or is actually no longer functional at all.

The further main component can be integrated into the drive train cooling unit, shielded from the cooling air flow of the fan through the drive train cooling unit. Further main components can also be integrated into the drive train cooling unit away from the primary cooling air flow of the fan through the drive train cooling unit. Furthermore, further main components can be integrated into a secondary cooling air flow and/or the primary cooling air flow of the fan through the drive train cooling unit, into the drive train cooling unit. In addition, the further main component can be integrated into a separate cooling air flow of the fan away from the primary cooling air flow through the drive train cooling unit and into the drive train cooling unit.

Fluid communication between the further main component and the radiator can be set up in the drive train cooling unit. Fluid communication between a first further main component and a second further main component can be set up in the drive train cooling unit. The drive train cooling unit can have a fluid connection for the further main component. This preferably substitutes one fluid connection of the radiator, wherein two fluid connections are eliminated, namely one on the radiator and one on the further main component. Furthermore, the drive train cooling unit can only have a single direct fluid connection for the radiator.

The drive train cooling unit can have an electrical power connection and/or an electrical communication connection for the further main component. The drive train cooling unit can have a single electrical power connection and/or a single electrical communication connection for all of its main components. The electrical power connection and the electrical communication connection of the drive train cooling unit can be combined into a single electrical connection. In the drive train cooling unit, a second further main component can receive its electrical current via a first further main component or separately. In the drive train cooling unit, a first main component can communicate electrically through a second further main component.

In addition to the radiator as the main component of the coolant circuit, the drive train cooling unit can have as a further main component of the coolant circuit: a coolant valve, a drive train coolant pump, a coolant expansion tank, and/or a sensor, with the coolant valve preferably comprising a bypass functionality.—The coolant valve can have two, three, four, five, or more fluid connections. A sensor can, for example, be designed as a pressure sensor, a temperature sensor, or a pressure and temperature sensor.

In a first embodiment, the drive train cooling unit has the coolant valve with bypass functionality. In a second embodiment, the drive train cooling unit has the coolant valve with bypass functionality and the drive train coolant pump. In a third embodiment, the drive train cooling unit has the coolant valve with bypass functionality, the drive train coolant pump, and the coolant expansion tank. In a fourth embodiment, the drive train cooling unit has the coolant valve with bypass functionality and the coolant expansion tank. In a fifth embodiment, the drive train cooling unit has the drive train coolant pump and the coolant expansion tank. In a sixth embodiment, the drive train cooling unit has the coolant expansion tank.

These enumerations are in relation to the three main components: Coolant valve with bypass functionality, drive train coolant pump, and coolant expansion tank at the end. Each of these six embodiments may further comprise or not comprise at least one additional sensor, i.e., not present in the prior art. Furthermore, a main component of the vehicle's coolant circuit not mentioned here may be present.

The drive train cooling unit can comprise at least one/the drive train coolant pump as a further main component, wherein the drive train coolant pump and/or an electronic system of the drive train coolant pump is/are set up in the drive train cooling unit in such a way that they can be supplied with a cooling air flow from the fan. The cooling air flow can be the primary cooling air flow, the secondary cooling air flow, and/or the separate cooling air flow of the fan (see above).

The bypass functionality of the coolant valve can be used to bypass the radiator of the drive train cooling unit. The coolant expansion tank can be integrated into the coolant circuit in series or in parallel. The drive train cooling unit can have one, in particular a single, centralized electronic system for its main components of the coolant circuit. These electronics can of course be set up not only for the main components of the coolant circuit, but also for other tasks, e.g., those of the drive train cooling unit.—The fan, the condenser, the radiator, and at least one further main component or the further main components can be set up in a single frame of the drive train cooling unit. The frame is naturally open at the front of the fan and at the rear of the radiator so that the primary cooling air flow from the fan can pass through the drive train cooling unit.

The invention integrates fluid-mechanically, electrically, and/or mechanically several main thermal components and possibly their necessary additional components of the coolant circuit into a drive train cooling unit, which, depending on a degree of integration of the drive train cooling unit, can lead to the following advantages. There are fewer components, as clamps, brackets, electrical connectors, etc. are no longer required. Packaging and/or assembly work at vehicle level is reduced. Overall, there are fewer hydraulic interfaces and therefore a reduced risk of leaks. A common frame (housing) and common electronics result in significantly reduced costs. Procurement costs are reduced. There is only one communication connection, which must be programmed and configured in the vehicle control unit. This results in improved system efficiency due to reduced pressure losses and reduced thermal losses due to shorter pipe and hose lengths. Etc.

The vehicle according to the invention has an electric traction motor and a drive train cooling unit according to the invention. A vehicle—in particular a motor vehicle (road vehicle), but also: a rail vehicle, a water vehicle, and/or an aircraft—with an electric traction motor is understood to be a motor vehicle which, in addition to an electric traction motor, can have a further non-electric drive, such as an internal combustion engine. This means that a vehicle with an electric traction motor can be, for example, a hybrid electric vehicle, an electric vehicle (electric motor drive only), a fuel cell vehicle, etc.

### BRIEF DESCRIPTION OF THE DRAWINGS

The invention is explained in more detail below with reference to the attached schematic drawing, which is not to scale, by means of exemplary embodiments. In the invention, a feature can be positive, i.e., present, or negative, i.e., absent. In this specification, a negative feature is not explicitly explained as a feature unless the invention emphasizes that it is absent, i.e., the invention actually made and not one constructed by the prior art consists in omitting this feature. The absence of a feature (negative feature) in an exemplary embodiment shows that the feature is optional.

The figures in the drawing are merely examples:

FIG. 1 shows an essential section of a coolant circuit according to the prior art for a vehicle with an electric traction motor, with a drive train cooling unit according to the prior art, and

FIG. 2 shows an overview of a plurality of embodiments of a drive train cooling unit according to the invention for a vehicle with an electric traction motor.

### DETAILED DESCRIPTION

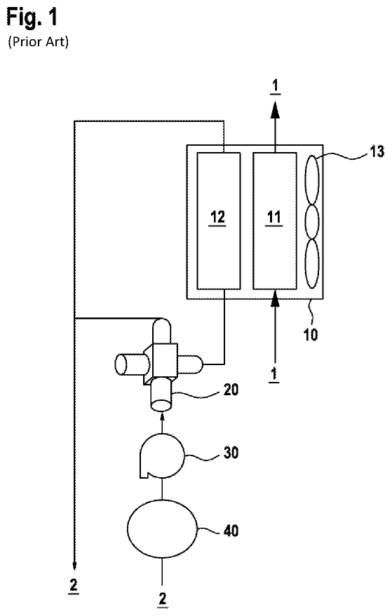

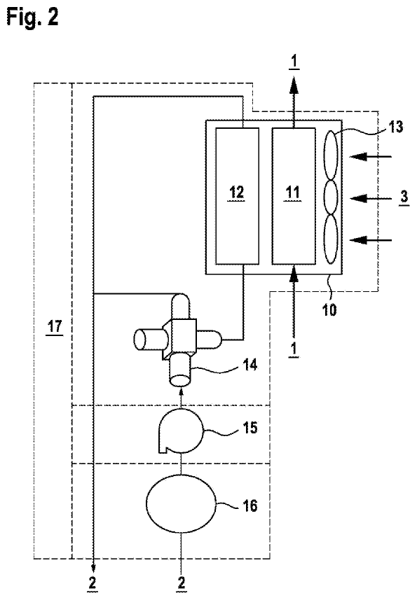

Based on the prior art (FIG. 1), the invention is explained in more detail with reference to exemplary embodiments of a plurality of embodiments of a drive train cooling unit 10 (FIG. 2) for a partially electrically or fully electrically driven vehicle. In the drawing, only those sections of the drive train cooling unit 10 and of a relevant section of a coolant circuit 2 of the vehicle are shown which are necessary for an understanding of the invention. Although the invention is described and illustrated in more detail by preferred exemplary embodiments, the invention is not limited by the disclosed exemplary embodiments. Other variations can be derived from this without leaving the scope of protection of the invention.

FIG. 1 shows an essential section of a coolant circuit 2 of a vehicle according to the prior art, wherein four main components 12, 20, 30, 40 of the coolant circuit 2 are shown. These are: a radiator 12, a coolant valve 20, a coolant pump 30, and a coolant expansion tank 40. The radiator 12 is part of a drive train cooling unit 10 (condenser-radiator-fan module, CRFM).

In the drive train cooling unit 10, a fan 13, a condenser 11 of a refrigerant circuit 1 of the vehicle, and the radiator 12 are connected together sequentially in series to form a cooling unit for a drive train of the vehicle. In one operation of the drive train cooling unit 10, the fan 13 generates a single flow of cooling air, which is directed from the drive train cooling unit 10 through the condenser 11 and the radiator 12, thus removing heat from the condenser 11 and the radiator 12.

These four main components 12, 20, 30, 40 are designed as individual components 12, 20, 30, 40 of the coolant circuit 2, designed separately from each other and installed in a vehicle depending on the local conditions and connected to each other electrically and fluid-mechanically. This results in a large number of cable harnesses, communication connections, (power) electronics, mechanical interfaces, hydraulic interfaces, etc. Furthermore, when designing a coolant circuit 2 for a vehicle, there is an increased effort for the procurement of individual components, a high effort for mechanical and electrical component integration and for setting up communication.—This results in significant overall costs for cooling the components in a partially electrically or fully electrically driven vehicle.

The invention, see FIG. 2, integrated in the drive train cooling unit 10 (embodiments dashed in FIG. 2) comprising the fan 13, the condenser 11, and the radiator 12, at least one of the following further main components 14, 15, 16, 17: a coolant valve 14, a drive train coolant pump 15, a coolant expansion tank 16, and/or a sensor 17. The coolant valve 14 preferably has a bypass function. A further main component of the vehicle's coolant circuit 2 can of course also be integrated into the drive train cooling unit.

Depending on the conditions in the vehicle, a desired level of integration, etc., one or a plurality of the further main components 14, 15, 16, 17 mentioned can be integrated into the drive train cooling unit 10. Preferably, if a sensor 17 is to be integrated into the drive train cooling unit 10, a corresponding further main component 14, 15, 16, 17 is also integrated into the drive train cooling unit 10.—Preferred embodiments are mentioned above in the description of the invention.

The further main components 14, 15, 16, 17 are integrated in/on a frame or housing of the drive train cooling unit 10.—The further main component 14, 15, 16, 17, in particular the drive train coolant pump 15, an electronic system of the further main component 14, 15, 16, 17, and/or a power electronic system of the drive train coolant pump 15 can be set up in the drive train cooling unit 10 in such a way that it can be cooled by a cooling air flow from the fan 13. The cooling air flow can be the primary cooling air flow 3, a secondary cooling air flow, and/or a separate cooling air flow of the fan 13.

In the direction of the primary cooling air flow 3 generated by the fan 13, the condenser 11 can be set up upstream of the radiator 12 in the drive train cooling unit 10. However, it is also possible to install the radiator 12 upstream of the condenser 11 in the drive train cooling unit 10 in the direction of the primary cooling air flow 3 generated by the fan 13. In both exemplary embodiments, the fan 13 is of course provided upstream of both the condenser 11 and the radiator 12 or both the radiator 12 and the condenser 11.

1. A drive train cooling unit (10) for a partially electrically or fully electrically driven vehicle, having
a fan (13), a condenser (11) for a refrigerant circuit (1) of the vehicle, and a radiator (12) for a coolant circuit (2) of the vehicle, the fan (13), the condenser (11), and the radiator (12) being connected together sequentially in series in a direction of air flow which can be caused by the fan (13) to form a cooling unit for a drive train of the vehicle, wherein
apart from the radiator (12) as a main component (12) of the coolant circuit (2), a further main component (14, 15, 16, 17) of the coolant circuit (2) of the vehicle is integrated into the drive train cooling unit (10).

2. The drive train cooling unit (10) according to claim 1, wherein the drive train cooling unit (10) is configured as a single functional and/or structurally closed assembly for cooling the drive train of the vehicle, which assembly can be installed as such on/in the vehicle.

3. The drive train cooling unit (10) according to claim 1, wherein the further main component (14, 15, 16, 17):
is integrated into the drive train cooling unit (10), shielded from a cooling air flow of the fan (13) through the drive train cooling unit (10),
is integrated into the drive train cooling unit (10), away from a primary cooling air flow (3) of the fan (13) through the drive train cooling unit (10),
is integrated into a secondary cooling air flow and/or the primary cooling air flow (3) of the fan (13) through the drive train cooling unit (10), into the drive train cooling unit (10), and/or
is integrated into a separate cooling air flow of the fan (13) away from the primary cooling air flow (3) through the drive train cooling unit (10), into the drive train cooling unit (10).

4. The drive train cooling unit (10) according to claim 1, wherein:
fluid communication of the further main component (14, 15, 16, 17) with the radiator (12) is provided in the drive train cooling unit (10),
a fluid communication of a first further main component (14, 15, 16, 17) with a second further main component (14, 15, 16, 17) is provided in the drive train cooling unit (10),
the drive train cooling unit (10) has a fluid connection of the further main component (14, 15, 16, 17), and/or.
the drive train cooling unit (10) has only one direct fluid connection for the radiator (12).

5. The drive train cooling unit (10) according to claim 1, wherein:
the drive train cooling unit (10) has an electrical power connection and/or an electrical communication connection for the further main component (14, 15, 16, 17),
the drive train cooling unit (10) has a single electrical power connection and/or a single electrical communication connection for all of its main components (14, 15, 16, 17), and/or
an electrical power connection and an electrical communication connection of the drive train cooling unit (10) are combined into a single electrical connection.

6. The drive train cooling unit (10) according to claim 1, wherein in that in the drive train cooling unit (10) a second further main component (14, 15, 16, 17) receives its electric current via a first further main component (14, 15, 16, 17) or separately therefrom, and/or
in the drive train cooling unit (10) an electrical communication of a first main component (14, 15, 16, 17) can take place through a second further main component (14, 15, 16, 17).

7. The drive train cooling unit (10) according to claim 1, wherein the drive train cooling unit (10), as a further main component (14, 15, 16, 17) of the coolant circuit (2):
has a coolant valve (14), a drive train coolant pump (15), a coolant expansion tank (16), and/or a sensor (17).

8. The drive train cooling unit (10) according to claim 1, wherein the drive train cooling unit (10) comprises as a further main component (14, 15, 16, 17) at least one drive train coolant pump (15), wherein
the drive train coolant pump (15) and/or electronics of the drive train coolant pump (15) is/are configured in the drive train cooling unit (10) in such a way to be supplied with a cooling air flow from the fan (13).

9. The drive train cooling unit (10) according to claim 12, wherein
the radiator (12) of the drive train cooling unit (10) can be bypassed by the bypass functionality of the coolant valve (14),
the coolant expansion tank (16) is integrated in series or in parallel into the coolant circuit (2), and/or
the drive train cooling unit (10) has an electronic system for its main components (12, 14, 15, 16, 17) of the coolant circuit (2).

10. The drive train cooling unit (10) according to claim 1, wherein the fan (13), the condenser (11), the radiator (12), and at least one further main component (14, 15, 16, 17) or the further main components (14, 15, 16, 17) are provided in a single frame of the drive train cooling unit (10).

11. A vehicle with an electric traction motor and a drive train cooling unit (10), wherein
the drive train cooling unit (10) is configured according to claim 1.

12. The drive train cooling unit (10) according to claim 7, wherein the coolant valve (14) comprises a bypass functionality.

13. The drive train cooling unit (10) according to claim 9, wherein the electronic system is a single, centralized electronic system for the main components (12, 14, 15, 16, 17) of the coolant circuit (2).
